(19) United States
(12) Patent Application Publication
(10) Pub. No.: US 2015/0023555 A1
(43) Pub. Date: Jan. 22, 2015

(54) COMMODITY RECOGNITION APPARATUS AND COMMODITY RECOGNITION METHOD

(71) Applicant: TOSHIBA TEC KABUSHIKI KAISHA, Tokyo (JP)

(72) Inventors: Atsushi Okamura, Iwanuma-shi (JP); Hiroshi Sugasawa, Miyagi-ken (JP)

(21) Appl. No.: 14/330,108

(22) Filed: Jul. 14, 2014

(30) Foreign Application Priority Data
Jul. 19, 2013 (JP) 2013-150471

(51) Int. Cl. G06K 9/46; G06K 9/62

(52) U.S. Cl. CPC G06K 9/4609; G06K 9/6267; G06K 9/6202
USPC 382/103

(57) ABSTRACT

In accordance with one embodiment, a commodity recognition apparatus receives, if a commodity is recognized as candidate of a target commodity by a recognition module, a selection input of the target commodity from the candidate; then adds appearance feature amount data to the feature amount data stored in a recognition dictionary file in association with an item of the target commodity the selection input of which is received; and meanwhile, writes log data containing the date and time when the appearance feature amount data is added to the recognition dictionary file in a log storage section.

### CROSS-REFERENCE TO RELATED APPLICATION

This application is based upon and claims the benefit of priority from Japanese Patent Application No. 2013-150471, filed Jul. 19, 2013, the entire contents of which are incorporated herein by reference.

### FIELD

Embodiments described herein relate to a commodity recognition apparatus which recognizes a commodity from an image obtained by photographing the commodity and a commodity recognition method for recognizing a commodity.

### BACKGROUND

There is a technology in which an object (commodity) is recognized from an image of the object captured by an image capturing section. In such a technology, an appearance feature amount of the object is extracted from the image and then compared with feature amount data of each reference image registered in a recognition dictionary file to calculate a similarity degree of the feature amounts. Then, an object equivalent to the reference image having the highest similarity degree is recognized as the object photographed by the image capturing section.

In recent years, it has been proposed to apply such an object recognition technology to a checkout system (POS system) of a retail store to recognize commodities purchased by a customer. In this case, feature amount data indicating the appearance feature amount of a commodity associated with items of each commodity, respectively, and specified with the item is registered in the recognition dictionary file in advance. However, the vegetables or fruits even of the same category may be different in appearance such as the color and the like due to the difference of producing district and harvest time and the like. It is necessary to rapidly update the feature amount data of the recognition dictionary file according to the change in the appearance of commodity. Thus, a device is needed which can be operated not only by an expert and the skilled but also by a general shop clerk to update the feature amount data of a commodity easily.

However, in a case where the feature amount data can be updated easily, there is a risk that the feature amount data is updated improperly and the quality of the feature amount data becomes low. In such an object recognition technology, if the quality of the feature amount data registered in the recognition dictionary file is poor, the recognition ability becomes low.

### BRIEF DESCRIPTION OF THE DRAWINGS

FIG. 1 is an external view illustrating a store checkout system according to one embodiment;

FIG. 2 is a block diagram illustrating the hardware constitutions of a scanner unit and a POS terminal of the store checkout system shown in FIG. 1;

FIG. 3 is a diagram schematically illustrating the structure of recognition dictionary data stored in a recognition dictionary file;

FIG. 4 is a diagram schematically illustrating the structure of recognition rate data stored in a recognition rate file;

FIG. 5 is a diagram schematically illustrating the structure of update log data stored in a log file;

FIG. 6 is a block diagram illustrating the functional components of a commodity recognition apparatus constituted by combining the scanner unit with the POS terminal;

FIG. 7 is a flowchart illustrating a procedure of information processing executed by a CPU of the POS terminal according to a commodity recognition program;

FIG. 8 is a flowchart specifically illustrating a procedure of recognition processing shown in FIG. 7;

FIG. 9 is a flowchart illustrating a procedure of information processing executed by the CPU of the POS terminal according to a recognition rate calculation program;

FIG. 10 is a flowchart illustrating a procedure of information processing executed by the CPU of the POS terminal according to a log verification program;

FIG. 11 is a diagram illustrating one example of a selection screen;

FIG. 12 is a diagram illustrating one example of a confirmation screen; and

FIG. 13 is a diagram illustrating one example of a log output result.

### DETAILED DESCRIPTION

In accordance with one embodiment, a commodity recognition apparatus comprises an extraction module, a recognition module, a reception module, an adding module and a log writing module. The extraction module extracts, from an image captured by an image capturing module, an appearance feature amount of a target commodity contained in the image. The recognition module compares the appearance feature amount data extracted by the extraction module with feature amount data of each commodity stored in a recognition dictionary file to recognize the target commodity. The reception module receives, if a commodity is recognized as candidate of the target commodity by the recognition module, a selection input of the target commodity from the candidate. The adding module adds the appearance feature amount data extracted by the extraction module to the feature amount data stored in the recognition dictionary file in association with an item of the target commodity the selection input of which is received by the reception module. The log writing module writes log data containing the date and time when the appearance feature amount data is added to the recognition dictionary file by the adding module in a log storage section.

An embodiment of the commodity recognition apparatus is described below with reference to the accompanying drawings.

In the present embodiment, the functions of the commodity recognition apparatus are included in a scanner unit 1 and a POS terminal 2 of a store checkout system.

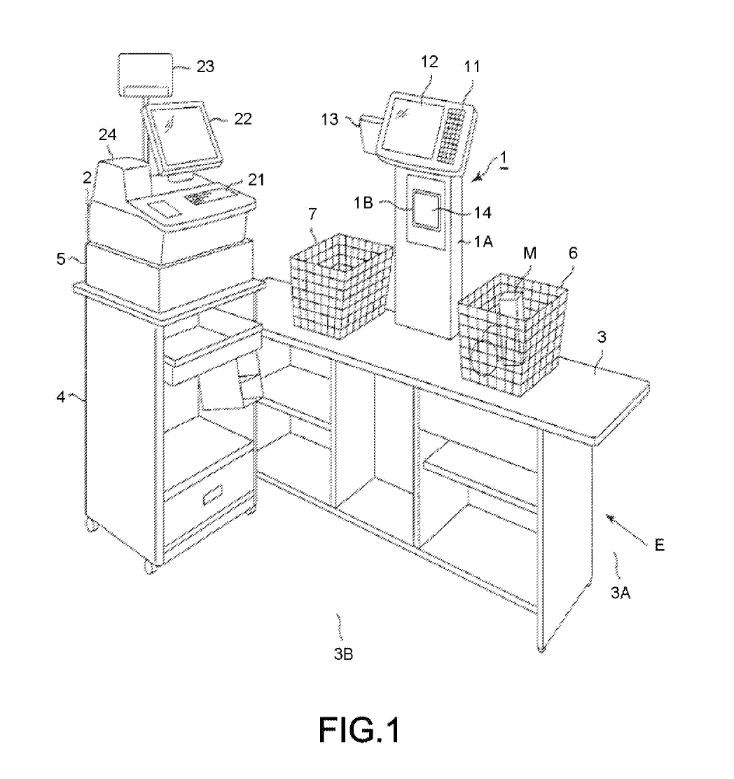

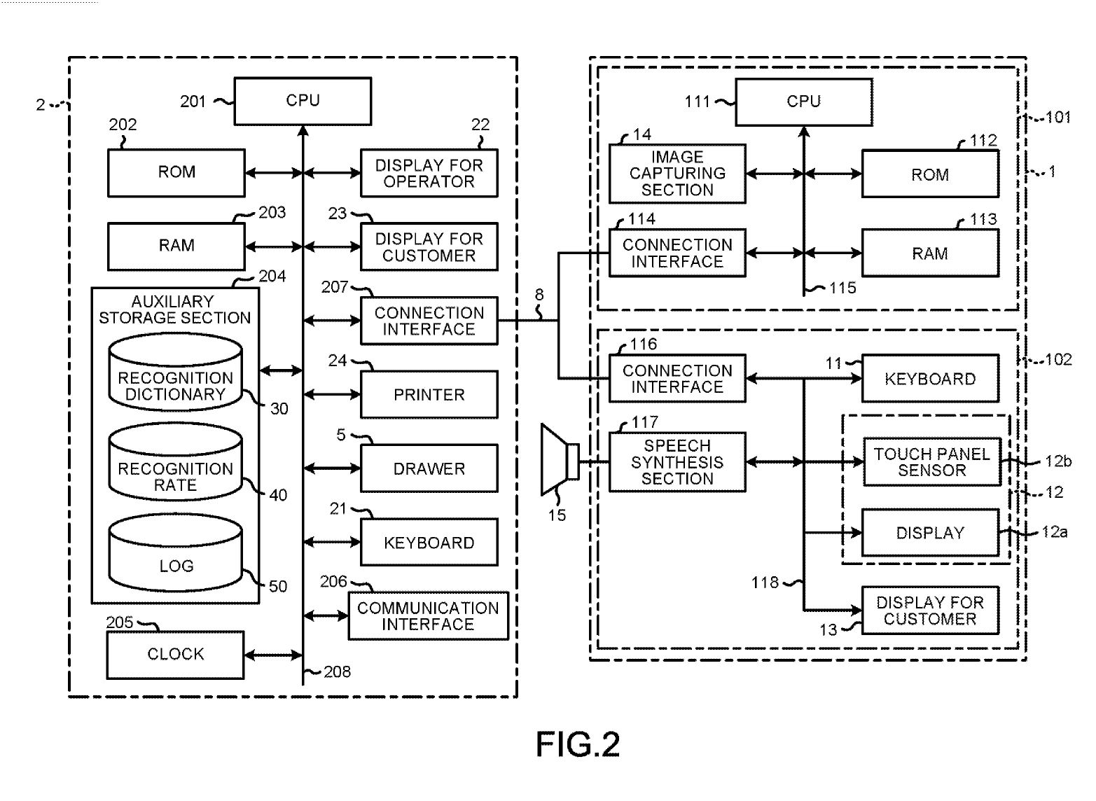

FIG. 1 is an external view of a store checkout system. The system includes a scanner unit 1 acting as a registration section for registering a commodity purchased by a customer and a POS (Point Of Sales) terminal 2 acting as a settlement section for processing the payment by the customer. The scanner unit 1 is mounted on a checkout counter 3. The POS terminal 2 is arranged on a register table 4 through a drawer 5. The scanner unit 1 and the POS terminal 2 are electrically connected with each other through a communication cable 8 (refer to FIG. 2).

The scanner unit 1 comprises a keyboard 11, a touch panel 12 and a display for customer 13. Those display or operation devices (keyboard 11, touch panel 12 and display for customer 13) are attached to a thin rectangular-shaped housing 1A constituting a main body of the scanner unit 1.

An image capturing section 14 is installed in the housing 1A. A reading window 1B is formed in a rectangular shape at the front side of the housing 1A. The image capturing section 14 comprises a CCD (Charge Coupled Device) image capturing element acting as an area image sensor, a drive circuit thereof, and an image capturing lens for focusing the image of an image capturing area on the CCD image capturing element. The image capturing area refers to the area of a frame image which is focused on the CCD image capturing element through the image capturing lens from the reading window 1B. The image capturing section 14 outputs the image focused on the image capturing area of the CCD image capturing element through the image capturing lens. The area image sensor, which is not limited to the CCD image capturing element, may be, for example, a CMOS (complementary metal oxide semiconductor) device.

The POS terminal 2 comprises a keyboard 21, a display for operator 22, a display for customer 23 and a receipt printer 24 as devices required for settlement.

The checkout counter 3 is arranged along a customer passage 3A. The register table 4 is arranged at a side opposite to the customer passage 3A with respect to the checkout counter 3 at a substantially right angle to the checkout counter 3. Specifically, the register table 4 is located at the end of the checkout counter 3 at the downstream side of the passage 3A in a movement direction of a customer indicated by an arrow E. Therefore, the checkout counter 3 and the register table 4 are arranged in an L-shape to define a space 3B for a shop clerk in charge of settlement, i.e., so called casher.

At the approximate center of the checkout counter 3, the housing 1A of the scanner unit 1 is vertically arranged such that the keyboard 11, the touch panel 12 and the reading window 1B are directed to the space for a shop clerk (cashier). The display for customer 13 of the scanner unit 1 is arranged on the housing 1A, facing to the customer passage 3A.

A first upper surface portion of the checkout counter 3 at the upstream side thereof through the scanner unit 1 in the customer movement direction serves as a space for placing a shopping basket 6 in which an unregistered commodity M purchased by a customer is held. On the other side, a second upper surface portion at the downstream side through the scanner unit 1 serves as an another space for placing a shopping basket 7 in which a commodity M registered by the scanner unit 1 is held.

FIG. 2 is a block diagram illustrating the hardware constitutions of the scanner unit 1 and the POS terminal 2. The scanner unit 1 comprises a scanner section 101 and an operation-output section 102. The scanner section 101 includes a CPU (Central Processing Unit) 111, a ROM (Read Only Memory) 112, a RAM (Random Access Memory) 113, a connection interface 114 and the image capturing section 14. The CPU 111, the ROM 112, the RAM 113 and the connection interface 114 are connected with each other via a bus line 115. The image capturing section 14 is connected with the bus line 115 via an input/output circuit (not shown).

The CPU 111 is a central part of a computer. The CPU 111 controls each section to achieve various functions of the scanner unit 1 according to an operating system or an application program.

The ROM 112 is amain storage part of the computer. The ROM 112 stores the operating system and the application program mentioned above. As occasion demands, the ROM 112 also stores data required to execute various processing by the CPU 111.

The RAM 113 is also a main storage part of the computer mentioned above. The RAM 113 stores data required to execute various processing by the CPU 111 as needed. The RAM 113 is also used as a work area for the CPU 111 when various processing is executed.

The operation-output section 102 includes the keyboard 11, the touch panel 12, the display for customer 13, a connection interface 116 and a speech synthesis section 117. The keyboard 11, the touch panel 12 and the display for customer 13 are connected with a bus line 118 via an input/output circuit (not shown), respectively. The connection interface 116 and the speech synthesis section 117 are also connected with the bus line 118.

The touch panel 12 comprises a panel type display 12a and a touch panel sensor 12b overlaid on the screen of the display 12a.

The speech synthesis section 117 outputs a speech or voice signal to a speaker 15 in response to a command input via the bus line 118. The speaker 15 converts the voice signal into a voice to output it.

The POS terminal 2 includes a CPU 201, a ROM 202, a RAM 203, an auxiliary storage section 204, a clock 205, a communication interface 206 and a connection interface 207. The POS terminal 2 further includes the keyboard 21, the display for operator 22, the display for customer 23 and the printer 24. The CPU 201, the ROM 202, the RAM 203, the auxiliary storage section 204, the clock 205, the communication interface 206 and the connection interface 207 are connected with each other via a bus line 208. In addition, the keyboard 21, the display for operator 22, the display for customer 23 and the printer 24 are connected with the bus line 208 via an input-output circuit (not shown). The drawer 5 is also connected with the bus line 208 via the input-output circuit (not shown).

The CPU 201 is a central part of a computer. The CPU 201 controls each section to achieve various functions of the POS terminal 2 according to an operating system or an application program.

The ROM 202 is amain storage part of the computer. The ROM 202 stores the operating system and the application program mentioned above. As occasion demands, the ROM 202 also stores data required to execute various processing by the CPU 201. The application program includes a commodity recognition program, a recognition rate calculation program and a log verification program described later.

The RAM 203 is also a main storage part of the computer mentioned above. The RAM 203 stores data required to execute various processing by the CPU 201 as needed. The RAM 203 is also used as a work area for the CPU 201 when various processing is executed. There is a sign-on area in the work areas. The sign-on area stores the information (for example, cashier ID, cashier name and the like) for identifying a cashier serving as a user of the POS terminal 2 according to a sign-on declaration of the cashier. By the way, the POS terminal 2 can carry out registration processing and the like of sold commodity in response to the sign-on declaration based on the cashier.

The clock 205 clocks the current date and time.

The communication interface 206 is connected with a store server (not shown) via a network such as a LAN (Local Area Network) and the like. Through this connection, the POS terminal 2 can perform a transmission/reception of data with the store server.

The connection interface 207 is connected with the two connection interfaces 114 and 116 of the scanner unit 1 via a communication cable 8. Through the connection, the POS terminal 2 sends various commands to the scanner unit 1. The POS terminal 2 receives information from the scanner section 101 of the scanner unit 1. On the other hand, the scanner unit 1 can access the data file stored in the auxiliary storage section 204 of the POS terminal 2 through this connection.

The auxiliary storage section 204, which is, for example, a HDD (Hard Disk Drive) device or a SSD (Solid State Drive) device, further stores data files such as a recognition dictionary file 30, a recognition rate file 40, a log file 50 and the like, in addition to various programs. As occasion demands, the auxiliary storage section 204 also stores the commodity recognition program, the recognition rate calculation program and the log verification program described later.

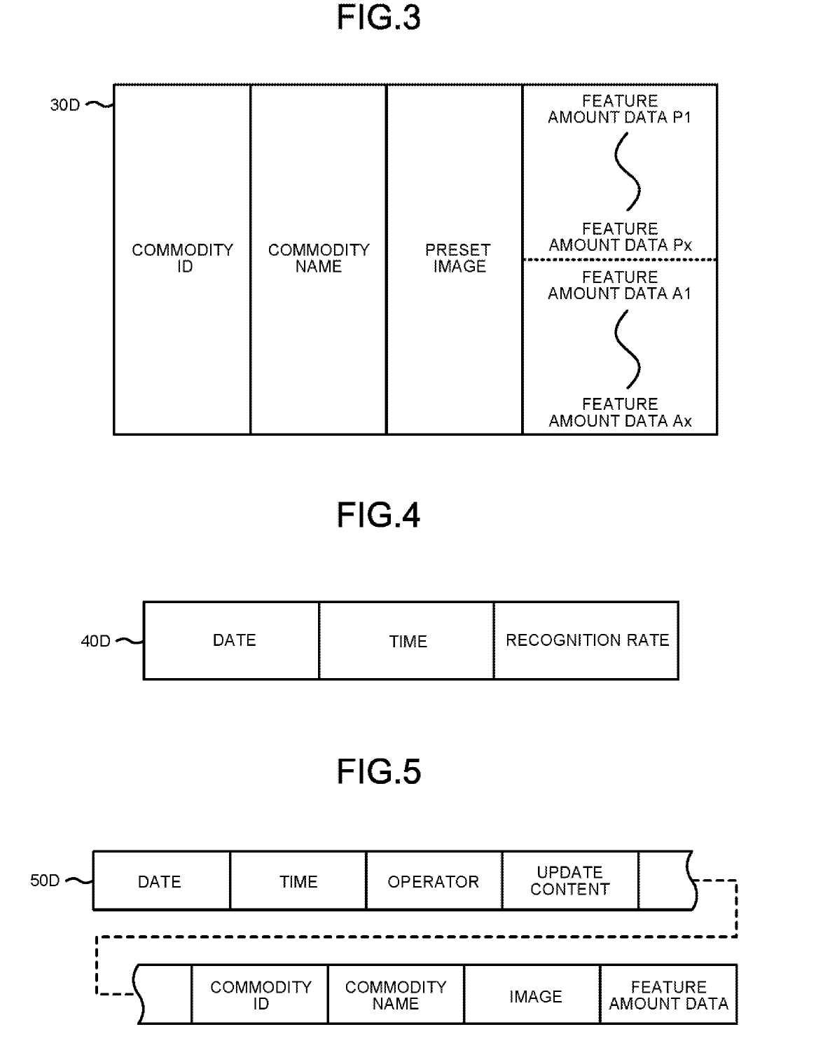

Recognition dictionary data 30D for each commodity is stored in the recognition dictionary file 30. FIG. 3 is a schematic view illustrating the structure of the recognition dictionary data 30D. As shown in FIG. 3, the recognition dictionary data 30D includes each item of commodity ID, commodity name, preset image and feature amount data.

The item of “commodity ID” is a unique code respectively attached to each commodity for identifying a commodity serving as a recognition target. The item of “commodity name” is an item of the commodity specified with a corresponding commodity ID. The item of “preset image” is an image representing the commodity specified with a corresponding commodity ID.

The item of “feature amount data” is data representing the appearance feature (appearance shape, color (hue), pattern, concave-convex (surface roughness) state and the like) of the commodity specified with a corresponding commodity ID in the form of parameters. The feature amount data includes a setting type (feature amount data P1-Px) and an additional type (feature amount data A1-Ax) in both of which the data structure is consistent. The feature amount data P1-Px of the setting type are obtained from a captured image of a standard commodity. The feature amount data A1-Ax of the additional type are obtained from a captured image of the commodity sold in the store. The standard commodity is a pre-selected commodity having a standard appearance.

The number of the feature amount data P1-Px and the number of the feature amount data A1-Ax contained in the recognition dictionary data 30D are not limited. However, there is a limit in the total number of the feature amount data P1-Px and the feature amount data A1-Ax. In a stage when the store checkout system is introduced initially, only the feature amount data P1-Px are contained in the recognition dictionary data 30D. The feature amount data A1-Ax are properly added in the actual operation of the system.

Recognition rate data 40D is stored in the recognition rate file 40. FIG. 4 is a schematic view illustrating the structure of the recognition rate data 40D. As shown in FIG. 4, the recognition rate data 40D contains each item of date, time and recognition rate.

The item of “recognition rate” is the percentage at which each commodity can be correctly recognized based on the recognition dictionary data 30D of each commodity stored in the recognition dictionary file 30. The recognition rate is calculated according to the recognition rate calculation program. The items of “date” and “time” are the date and time when the corresponding recognition rate is calculated. Herein, the recognition rate file 40 functions as a recognition rate storage section.

Update log data 50D is stored in the log file 50. FIG. 5 is a schematic view illustrating the structure of the update log data 50D. As shown in FIG. 5, the update log data 50D contains each item of date, time, operator, update content, commodity ID, commodity name, image and feature amount data. The update log data 50D is generated as a record when the recognition dictionary data 30D stored in the recognition dictionary file 30 is updated, and then stored in the log file 50. The update log data 50D includes an additional log data 50D1 generated when the feature amount data A1-Ax are added to the recognition dictionary data 30D and a deleted log data 50D2 generated when the feature amount data A1-Ax are deleted.

The items of “date” and “time” are the date and time when the recognition dictionary data 30D is updated. The item of “operator” is the cashier identification information stored in the sign-on area when the recognition dictionary data 30D is updated. The item of “update content” is the information (for example, “adding” in a case of the additional log data 50D1 and “deleting ” in a case of the deleted log data 50D2) for identifying whether the update log data 50D is the additional log data 50D1 or the deleted log data 50D2.

The items of “commodity ID” and “commodity name” are the information contained in the updated recognition dictionary data 30D. The item of “image” is a commodity image serving as the source of the feature amount data added to the recognition dictionary data 30D. There is no image in the deleted log data 50D2. The item of “feature amount data” is the feature amount data added to the recognition dictionary data 30D in a case of the additional log data 50D1, or the feature amount data deleted from the recognition dictionary data 30D in a case of the deleted log data 50D2. Herein, the log file 50 functions as a log storage section.

For example, the recognition rate data 40D and the update log data 50D are erased if a given time elapses from the moment the recognition rate data 40D and the update log data 50D are stored in the recognition rate file 40 and the log file 50.

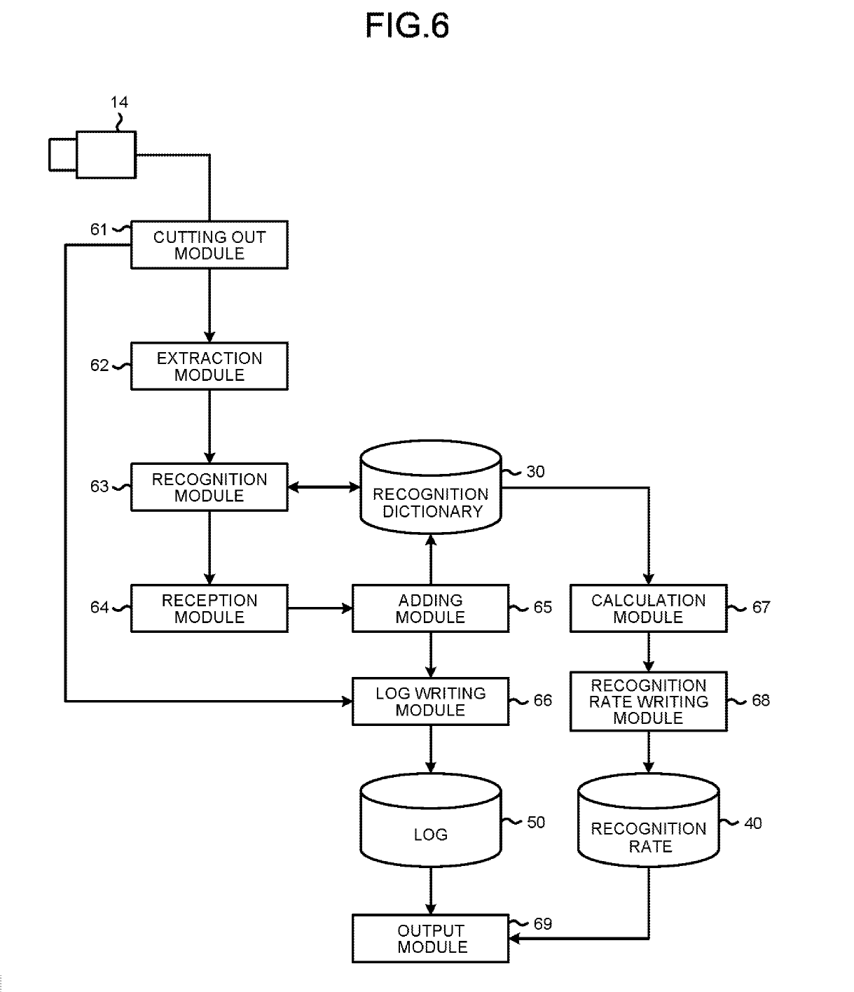

FIG. 6 is a block diagram illustrating the functional components of the commodity recognition apparatus constituted by combining the scanner unit 1 with the POS terminal 2. As shown in FIG. 6, the scanner unit 1 and the POS terminal 2 comprises a cutting out module 61, an extraction module 62, a recognition module 63, a reception module 64, an adding module 65, a log writing module 66, a calculation module 67, a recognition rate writing module 68 and an output module 69 to realize the functions of the commodity recognition apparatus.

The cutting out module 61 cuts out an image of a target commodity from an image captured by the image capturing section 14.

The extraction module 62 extracts appearance feature amount such as the shape, surface color, pattern, concave-convex state and the like of a target commodity from the image of the target commodity cut out by the cutting out module 61.

The recognition module 63 compares the appearance feature amount extracted by the extraction module 62 with the feature amount data of each commodity registered in the recognition dictionary file 30 in sequence to recognize the target commodity.

The reception module 64 receives, in a case where a commodity is recognized as candidate of the target commodity by the recognition module 63, an input of selecting the target commodity from the candidate. The candidate may be plural.

The adding module 65 adds the appearance feature amount data extracted by the extraction module 62 to the feature amount data stored in the recognition dictionary file 30 in association with the items of the target commodity of which the selection input is received by the reception module 64. The adding module 65 deletes the feature amount data stored in the recognition dictionary file 30 as needed.

The log writing module 66 writes the additional log data 50D1 in the log file 50 when the adding module 65 adds the appearance feature amount data to the recognition dictionary file 30. The log writing module 66 further writes the deleted log data 50D2 in the log file 50 when the feature amount data is deleted from the recognition dictionary file 30.

The calculation module 67 calculates a correct recognition rate for correctly recognizing each commodity through the recognition module 63 using the recognition dictionary data 30D of each commodity stored in the recognition dictionary file 30.

The recognition rate writing module 68 writes the correct recognition rate calculated by the calculation module 67 in the recognition rate file 40 together with the date and time when the correct recognition rate is calculated.

The output module 69 visually outputs the update log data 50D (the additional log data 50D1 and the deleted log data 50D2) stored in the log file 50 through a display module or a printing module. The output module 69 also visually outputs, in association with the update log data 50D, the correct recognition rate stored in the recognition rate file 40 together with the closest date and time after the date and time contained in the update log data 50D.

Each of the modules 61-69 described above are realized through an information processing executed by the CPU 201 of the POS terminal 2 according to the commodity recognition program, the recognition rate calculation program and the log verification program.

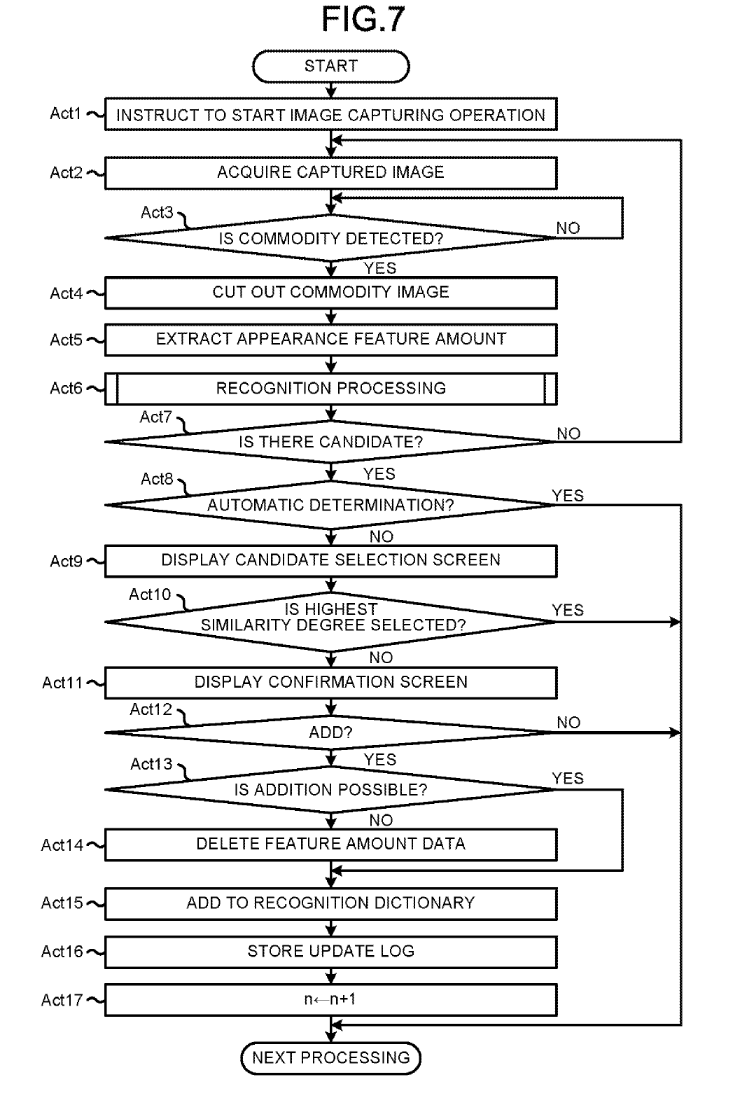

FIG. 7 is a flowchart illustrating a procedure of the information processing executed by the CPU 201 according to the commodity recognition program. In the POS terminal 2 where a sign-on declaration is carried out by a cashier, the commodity recognition program is started if a commodity registration mode for executing registration processing of the sold commodity is selected. In response to the start, the CPU 201 starts the information processing of a procedure shown in the flowchart of FIG. 7.

First, the CPU 201 sends a command instructing to start the image capturing operation to the scanner unit 1 (ACT 1). After receiving the command, the CPU 111 of the scanner unit 1 outputs an ON-signal of image capturing to the image capturing section 14. The image capturing section 14 starts the image capturing operation to photograph the image capturing area according to the ON-signal of image capturing. The frame images of the image capturing area captured by the image capturing section 14 are stored in a work area (hereinafter referred to as an image area) for storing the image data formed in the RAM 113 in sequence. Thus, if the cashier holds the commodity to the reading window 1B, the frame images obtained by photographing the commodity are stored in the image area in sequence.

The CPU 201 outputs a command instructing to acquire the captured image to the scanner unit 1 (ACT 2). After receiving the command, the CPU 111 acquires the frame image stored in the image area. Then the CPU 111 confirms whether or not the commodity is imaged in the frame image. If the commodity is not imaged in the frame image, the CPU 111 acquires a next frame image from the image area. The CPU 111 confirms whether or not the commodity is imaged in the frame image and if the commodity is imaged in the frame image, the CPU 111 sends the data of the frame image to the POS terminal 2.

The CPU 201 waits for the frame image in which the commodity is imaged (ACT 3). If the data of the frame image is received from the scanner unit 1 (YES in ACT 3), the CPU 201 detects the contour line of the commodity from the frame image and cuts out the captured image along the contour line. The CPU 201 stores the cut out captured image, that is, the data of the captured image of the commodity, in a cut out image work area (hereinafter referred to as cut out area) formed in the RAM 203 (ACT 4: cutting out module 61). Next, the CPU 201 extracts appearance feature amount such as shape, surface color, pattern, concave-convex state and the like of the commodity from the data of the cut out captured image of the commodity. The CPU 201 stores the extracted appearance feature amount data in a feature amount work area (hereinafter referred to as feature amount area) formed in the RAM 203 (ACT 5: extraction module 62).

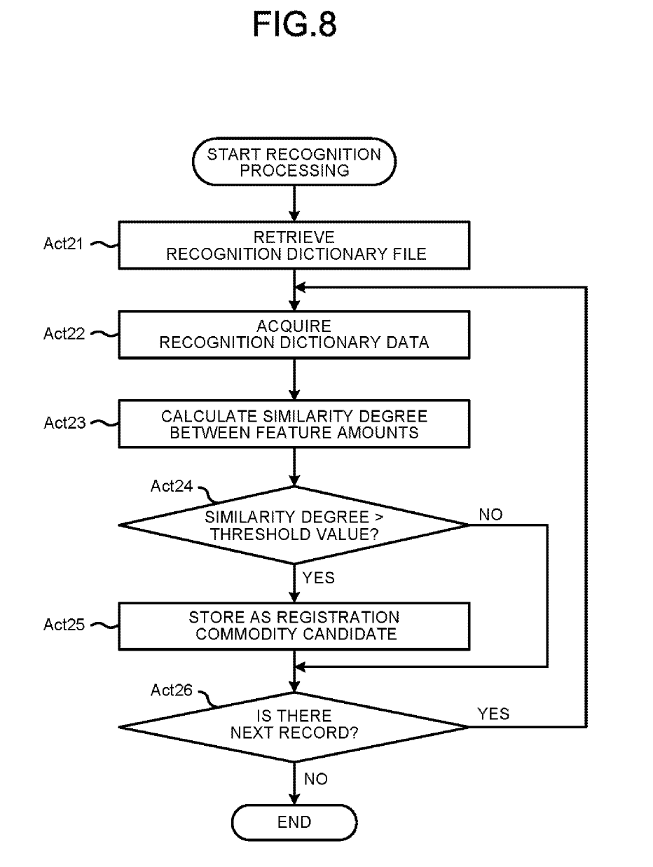

After the appearance feature amount is extracted, the CPU 201 executes a recognition processing of a procedure specifically illustrated in the flowchart of FIG. 8 (ACT 6: recognition module 63). First, the CPU 201 retrieves the recognition dictionary file 30 (ACT 21). The CPU 201 acquires the recognition dictionary data 30D of one commodity from the recognition dictionary file 30 (ACT 22).

After the recognition dictionary data 30D is acquired, the CPU 201 calculates a similarity degree which indicates, with hamming distance for example, how much similar the appearance feature amount data in the feature amount area is to each feature amount data of the recognition dictionary data 30D (ACT 23). In the present embodiment, the similarity degree is calculated within a range from “0” to “100”, and the more similar the feature amount data are to each other, the greater the value is.

The CPU 201 confirms whether or not the calculated similarity degree is greater than a given reference threshold value (ACT 24). The reference threshold value is the lower limit of the similarity degree of a commodity according to which the commodity can be remained as the registration commodity candidate. In the present embodiment, the reference threshold value is set to ⅕ of the upper limit value (100) of the similarity degree, that is, “20”. If the similarity degree is at a level higher than the reference threshold value (YES in ACT 24), the CPU 201 stores the commodity ID and the commodity name of the recognition dictionary data 30D, the appearance feature amount data in the feature amount area and the similarity degree calculated in the processing in ACT 23 in a registration commodity candidate work area (hereinafter referred to as candidate area) formed in the RAM 203 (ACT 25). Then the CPU 201 executes the processing in ACT 26. On the contrary, if the similarity degree is not greater than the reference threshold value (NO in ACT 24), the CPU 201 executes the processing in ACT 26 without executing the processing in ACT 25.

In ACT 26, the CPU 201 confirms whether or not there is unprocessed recognition dictionary data 30D in the recognition dictionary file 30. If there is unprocessed recognition dictionary data 30D (YES in ACT 26), the CPU 201 returns to execute the processing in ACT 22. That is, the CPU 201 acquires the unprocessed recognition dictionary data 30D from the recognition dictionary file 30 and then executes the processing in ACT 23-ACT 26.

In this way, the CPU 201 sequentially executes the processing in ACT 23-ACT 26 on the recognition dictionary data 30D of each commodity stored in the recognition dictionary file 30. If the CPU 201 confirms that there is no unprocessed recognition dictionary data 30D (NO in ACT 26), the recognition processing is ended.

After the recognition processing is ended, the CPU 201 confirms whether or not there is a registration commodity candidate (ACT 7 in FIG. 7). If there is no data of the registration commodity candidate in the candidate area, it can be determined that there is no registration commodity candidate. In this case (NO in ACT 7), the CPU 201 returns to the processing in ACT 2. That is, the CPU 201 outputs a command instructing to acquire the captured image to the scanner unit 1. After the frame image in which the commodity is imaged is received, the CPU 201 executes the processing in ACT 4-ACT 6 on the image.

On the other hand, if there is one or more registration commodity candidate data (commodity ID, commodity name, appearance feature amount and similarity degree) stored in the candidate area, it can be determined that there is registration commodity candidate. In this case (YES in ACT 7), the CPU 201 confirms whether or not to automatically determine the registration commodity (ACT 8). Specifically, the CPU 201 confirms whether or not there is only one data of which the similarity degree is greater than a given determination threshold value in the registration commodity candidate data. The determination threshold value is set to a value (for example, 80) which is much greater than the reference threshold value.

If there is only one commodity of which the similarity degree is greater than the determination threshold value in the registration commodity candidate, the commodity is automatically determined as the registration commodity. On the contrary, if there is no commodity or if there is more than one commodity of which the similarity degree is greater than the determination threshold value, the registration commodity is not determined. If the registration commodity is automatically determined (YES in ACT 8), the CPU 201 proceeds to a next processing, that is, the registration processing routine of the automatically determined commodity without executing the processing in ACT 9-ACT 17 which will be described later.

On the contrary, if the registration commodity is not determined (NO in ACT 8), the CPU 201 displays a selection screen 70 of registration commodity candidates on the touch panel 12 based on the data of the candidate area (ACT 9: reception module 64).

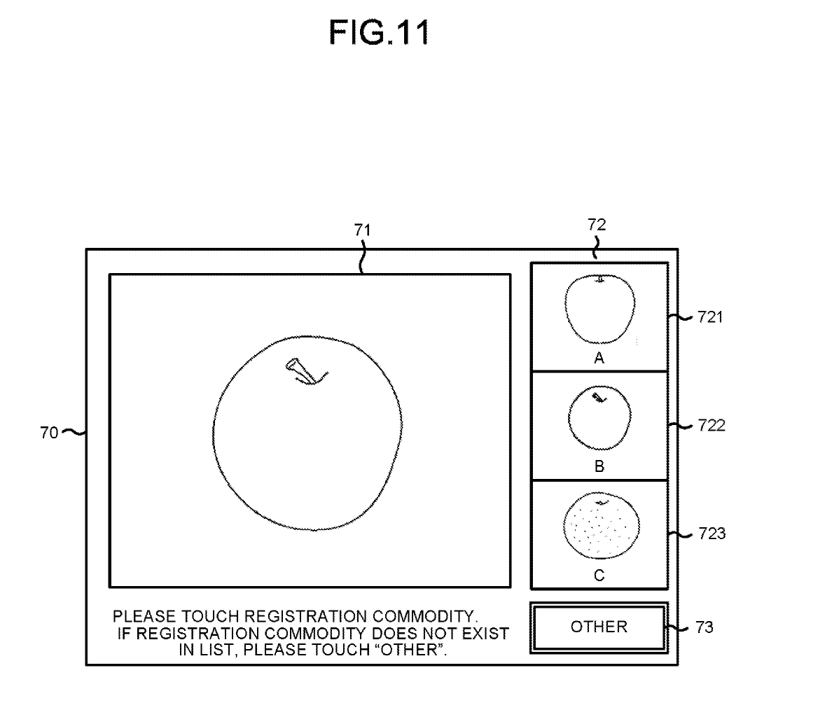

An example of the selection screen 70 is shown in FIG. 11. As shown in FIG. 11, the selection screen 70 is divided into a captured image display area 71 and a candidate commodity display area 72. An “other” button 73 is also displayed on the selection screen 70. The captured image of the commodity stored in the cut out area is displayed in the display area 71. The display area 72 is further divided into three areas 721, 722 and 723, and the preset images and the commodity names of the commodities serving as registration commodity candidates are displayed from the area 721 on the screen in the descending order of the similarity degree.

By the way, the preset images and the commodity names of the commodities of which the similarity degrees are ranked at the first three places are displayed on the first screen of the display area 72 (721, 722, 723) in sequence. If the “other” button 73 is touched in this state, the display area 72 switches to the preset images and the commodity names of the commodities of which the similarity degrees are ranked at the fourth place to the sixth place. Like this, every time the “other” button 73 is touched, the images of the area 72 are switched to display the preset images and the commodity names of the following commodities of which the similarity degrees are lower than that of the current displayed commodities, and if the preset image and the commodity name of the commodity of which the similarity degree is ranked at the last place, that is, the commodity having the lowest similarity degree, is displayed, it returns to the first.

The cashier holding the commodity to the reading window 1B looks for the area 721, 722 or 723 where the preset image and the commodity name of the commodity are displayed from the display area 72. If the area 721, 722 or 723 is found, the cashier touches the area 721, 722 or 723.

The CPU 201 waits until the display area 721, 722 or 723 is touched. If the display area 721, 722 or 723 is touched, the CPU 201 moves the commodity ID, commodity name, appearance feature amount and the similarity degree of the commodity of which the preset image and the like are displayed in the area 721, 722 or 723 from the candidate area to a selection commodity work area (hereinafter referred to as selection area) formed in the RAM 203. Returning to FIG. 7, the CPU 201 confirms the order of the similarity degree stored in the selection area (ACT 10). If the area 721 where the commodity having the highest similarity degree is displayed is touched (YES in ACT 10), the CPU 201 proceeds to a next processing, that is, the registration processing routine of the commodity having the highest similarity degree without executing the processing in ACT 11-ACT 17 which will be described later.

On the contrary, if the area 721, 722 or 723 where the commodity of which the similarity degree is ranked at the second place or below is displayed is touched (NO in ACT 10), the CPU 201 displays an addition confirmation screen 80 on the touch panel 12 (ACT 11).

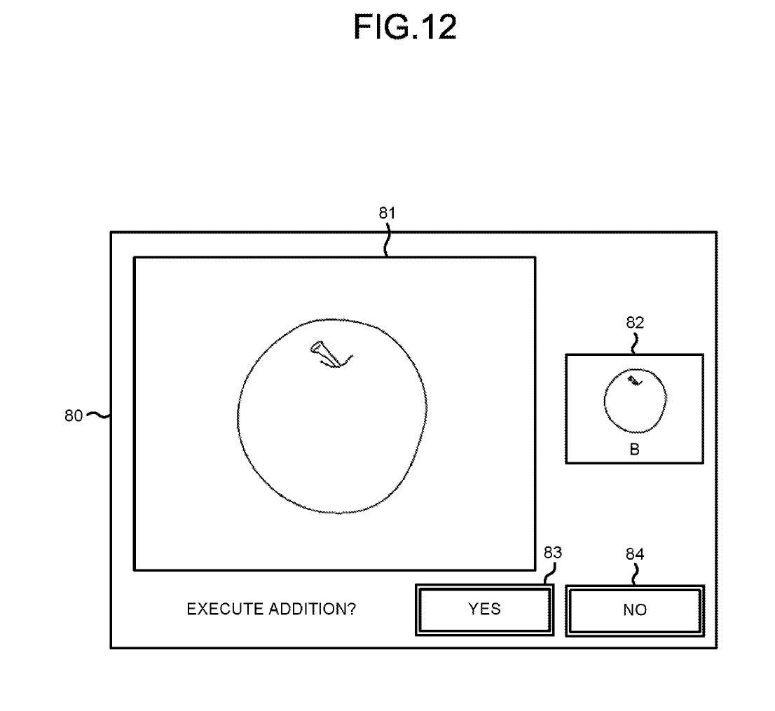

One example of the confirmation screen 80 is shown in FIG. 12. As shown in FIG. 12, the confirmation screen 80 is divided into a captured image display area 81 and a selection commodity display area 82. A “YES” button 83 and a “NO” button 84 are also displayed on the confirmation screen 80. The captured image of a commodity stored in the cut out area is displayed in the display area 81. The preset image and the commodity name of the commodity selected on the selection screen 70 are displayed on the display area 82. FIG. 12 shows a confirmation screen 80 in a case where the commodity B of which the preset image and the like are displayed in the area 722 is selected on the selection screen 70 shown in FIG. 11.

The cashier determines whether or not to execute addition. In a case of executing addition, the “YES” button 83 is touched, and in case of not executing addition, the “NO” button 84 is touched. For example, in a case where the commodity held to the reading window 1B is vegetable or fruit, the commodity even of the same category may be different in appearance such as the color and the like due to the difference of producing district and harvest time and the like. Thus, the cashier executes addition if it is determined that the similarity degree is ranked at the second place or below because of the difference in appearance with the standard commodity due to the difference of producing district and harvest time and the like, and does not execute addition if it is determined that the commodity is different from the standard commodity in appearance fortuitously.

The CPU 201 waits until either the “YES” button 83 or the “NO” button 84 is touched (ACT 12). Herein, if the “NO” button 84 is touched (NO in ACT 12), the CPU 201 proceeds to a next processing, that is, the registration processing routine of the commodity specified with the commodity ID in the selection area without executing the processing in ACT 13-ACT 17 which will be described later.

On the contrary, if the “YES” button 83 is touched (YES in ACT 12), the CPU 201 confirms whether or not the feature amount data can be added to the recognition dictionary data 30D (ACT 13). That is, the CPU 201 confirms whether or not the total number of the feature amount data registered in the recognition dictionary data 30D containing the commodity IDs and commodity names in the selection area reaches the upper limit value. If it does not reach the upper limit value, the addition processing can be executed, and if it reaches the upper limit value, the addition processing cannot be executed.

In a case where the addition is impossible (NO in ACT 13), the CPU 201 deletes any one feature amount data from the recognition dictionary data 30D (ACT 14). For example, the CPU 201 deletes the feature amount data which is added earliest from the feature amount data A1-Ax added to the recognition dictionary data 30D. At this time, the CPU 201 stores the deleted feature amount data together with the commodity ID and commodity name of the recognition dictionary data 30D in a deleting work area (hereinafter referred to as deleting area) formed in the RAM 203.

After the processing in ACT 14 is executed, or if it is determined that the addition is possible in ACT 13 (YES in ACT 13), the CPU 201 adds the appearance feature amount data in the selection area to the recognition dictionary data 30D (ACT 15: adding module 65).

Next, the CPU 201 executes a processing of storing the update log data 50D (ACT 15: log writing module 66). That is, the CPU 201 creates the additional log data 50D1 for making the data of the item of “update content” to be “adding” and stores it in the log file 50. In the additional log data 50D1, the data of the items of “date” and “time” is the data of the current date and time clocked by the clock 205. The data of the item of “operator” is the cashier identification information stored in the sign-on area. The data of the item of “image” is the captured image of the commodity stored in the cut out area. The items of “commodity ID”, “commodity name” and “feature amount data” are the commodity ID, commodity name and the appearance feature amount data stored in the selection area. The data of the item of “feature amount data” may also be the appearance feature amount data stored in the feature amount area.

If the processing of deleting the feature amount data is executed in the processing in ACT 14, the CPU 201 creates the deleted log data 50D2 for making the data of the item of “update content” to be “deleting” and stores it in the log file 50. In the deleted log data 50D2, the data of the items of “date” and “time” is the data of the current date and time clocked by the clock 205. The data of the item of “operator” is the cashier identification information stored in the sign-on area. The items of “commodity ID”, “commodity name” and “feature amount data” are the commodity ID, commodity name and the feature amount data stored in the deleting area.

After the update log data 50D is stored, the CPU 201 increases an update times counter n by “1” (ACT 17). The update times counter n of which the initial value is “0” is an adding counter which is increased by “1” every time the processing in ACT 17 is executed. Sequentially, the CPU 201 proceeds to a next processing, that is, the registration processing routine of the commodity specified with the commodity ID in the selection area.

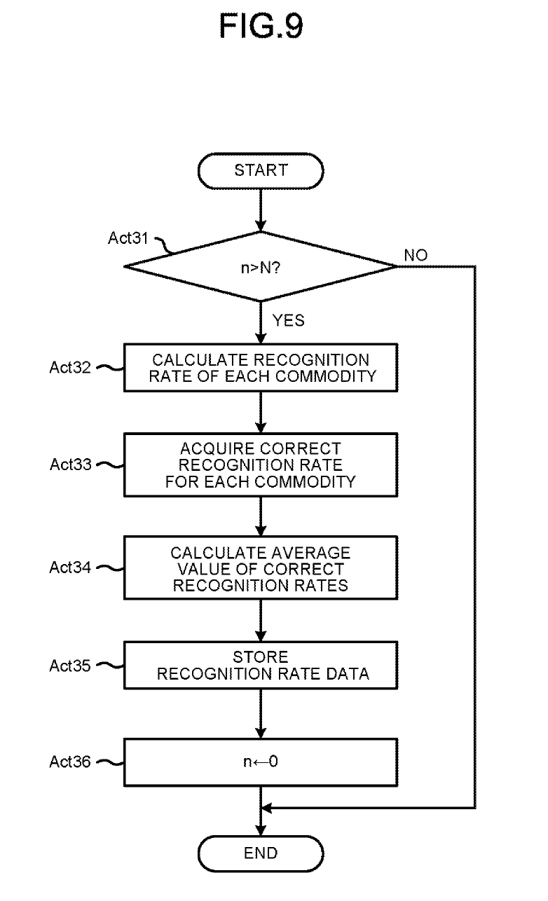

FIG. 9 is a flowchart illustrating a procedure of information processing executed by the CPU 201 according to the recognition rate calculation program. For example, in the POS terminal 2, a timer interrupt signal occurs every time the time clocked by the clock 205 becomes longer than a given time. The recognition rate calculation program is started in response to the timer interrupt signal. If the recognition rate calculation program is started, the CPU 201 starts the information processing of a procedure shown in the flowchart in FIG. 9.

First, the CPU 201 determines whether or not the update times counter n is greater than a threshold value N (ACT 31). If the update times counter n is not greater than the threshold value N (NO in ACT 31), the CPU 201 ends the processing. On the contrary, if the update times counter n is greater than the threshold value N (YES in ACT 31), the CPU 201 executes each processing in ACT 32-ACT 36 which will be described later.

As stated above, the update times counter n is increased every time the update log data 50D is written in the log file 50, that is, every time the feature amount data of the recognition dictionary data 30D stored in the recognition dictionary file 30 is updated. Thus, if the number of times the feature amount data of the recognition dictionary data 30D is updated is greater than the threshold value N, each processing in ACT 32-ACT 36 is executed. The threshold value N is not limited. For example, if each processing in ACT 32-ACT 36 is executed every time the feature amount data of the recognition dictionary data 30D is updated, the threshold value N is set to “0”. If each processing in ACT 32-ACT 36 is executed after the feature amount data of the recognition dictionary data 30D is updated for ten times, the threshold value N is set to “9”. Such a threshold value N may be a fixed value, alternatively, the threshold value N may be changed, for example, through a designation of a user.

In ACT 32, the CPU 201 calculates the recognition rate by item for each commodity using the recognition dictionary data 30D of each commodity stored in the recognition dictionary file 30. Specifically, the CPU 201 reads the recognition dictionary data 30D from the recognition dictionary file 30 in order. Every time the recognition dictionary data 30D is read, the CPU 201 selects a given number (for example, ten) of feature amount data from the plurality of feature amount data contained in the recognition dictionary data 30D. The CPU 201 repeats the following processing every time the feature amount data is selected.

That is, the CPU 201 regards the selected feature amount data as the appearance feature amount obtained from the captured image of the commodity specified with the commodity ID of the recognition dictionary data 30D. Then the CPU 201 sequentially compares the appearance feature amount with the feature amount data of each commodity registered in the recognition dictionary file 30 to calculate a similarity degree by item.

In this way, after the similarity degree by item is calculated individually for each of the selected feature amount data, the CPU 201 calculates the average of the similarity degree by item. Then the CPU 201 converts the average value of the similarity degree by item into a percentage to calculate the recognition rate by item of the commodity specified with the commodity ID of the recognition dictionary data 30D.

In ACT 33, the CPU 201 acquires the correct recognition rate for each commodity. The correct recognition rate refers to a rate at which a commodity is correctly recognized. That is, the CPU 201 acquires the recognition rate of the item of the commodity from the recognition rate by item calculated in the processing in ACT 32 as the correct recognition rate for each commodity.

In ACT 34, the CPU 201 calculates an average value of the correct recognition rates acquired for each commodity.

In ACT 35, the CPU 201 stores the recognition rate data 40D containing the average value of the correct recognition rates in the recognition rate file 40. That is, the CPU 201 acquires the current date and time data clocked by the clock 205 and generates the recognition rate data 40D from the date and time data and the average value of the correct recognition rates. Then the CPU 201 writes the recognition rate data 40D in the recognition rate file 40.

In ACT 36, the CPU 201 resets the update times counter n to “0”. In this way, the information processing according to the recognition rate calculation program is ended.

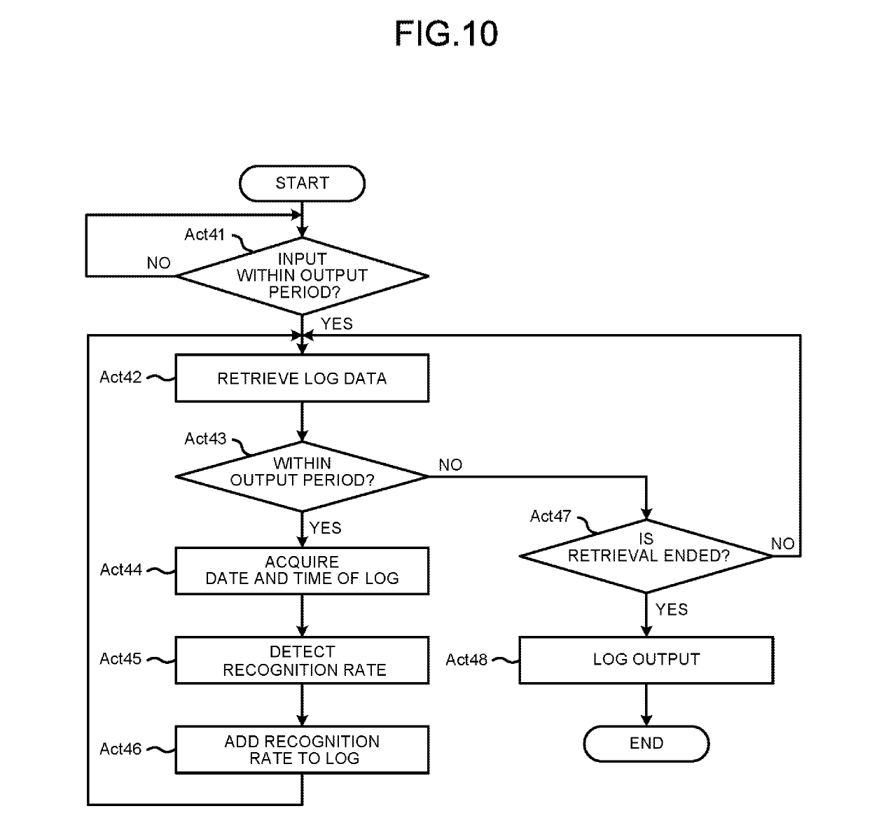

FIG. 10 is a flowchart illustrating a procedure of information processing executed by the CPU 201 according to the log verification program. In the POS terminal 2, there is a maintenance mode as an operation mode. There is a user restrict in the maintenance mode so that the maintenance mode can only be executed by, for example, a person of the maker in charge of the maintenance job. The log verification program can be started in the maintenance mode.

That is, in the maintenance mode, if the log verification job is selected from various job menus, the log verification program is started. If the log verification program is started, the CPU 201 starts the information processing of a procedure shown in the flowchart in FIG. 10.

First, the CPU 201 displays an input screen of the log output period on the display for operator 22, and waits until the output period of the log data is input (ACT 41). As a method of inputting the output period, a method of inputting the start date and the end date, or a method of inputting the start date only and taking the current date as the end date may be used. In either of the cases, the person in charge of the maintenance job operates the keyboard 21 to input the output period.

If the output period is input (YES in ACT 41), the CPU 201 retrieves the log file 50 and reads the additional log data 50D1 or the deleted log data 50D2 stored in the log file 50 in the order of older date and time (ACT 42). Every time the log data is read, the CPU 201 determines whether or not the date of the log data is within the output period (ACT 43). If it is not in the output period (NO in ACT 43), the CPU 201 discards the log data 50D. Then the CPU 201 determines whether or not the retrieval of the log file 50 is ended (ACT 47). If the retrieval is not ended (NO in ACT 47), the CPU 201 continues the retrieval of the log file 50 (ACT 42).

If the log data 50D of which the date is within the output period is read (YES in ACT 43), the CPU 201 acquires date and time from the log data 50D (ACT 44). Then the CPU 201 retrieves the recognition rate file 40 with the date and time to detect a recognition rate data 40D of which the date and time is the closest time after the date and time of the log data from all the recognition rate data 40Ds (ACT 45).

If a corresponding recognition rate data 40D is detected, the CPU 201 adds the recognition rate of the recognition rate data 40D to the log data 50D. Then the CPU 201 stores the log data 50D added with the recognition rate in a log output work area (hereinafter referred to as log output area) formed in the RAM 203 (ACT 46).

Every time the log data 50D of which the date is within the output period is detected from the log file 50, the CPU 201 executes the processing in ACT 44-ACT 46. In this way, the log data 50D of which the date is within the output period is stored in the log output area together with the recognition rate (average of the correct recognition rates) of the recognition rate data 40D which is the closest in time after the date of the update log data 50D.

After the log data 50D having the newest date and time stored in the log file 50 is read, the CPU 201 recognizes that the retrieval of the log file 50 is ended. Alternatively, if the log data 50D of which the date is after the final date of the output period is read, it is recognized that the retrieval of the log file 50 is ended.

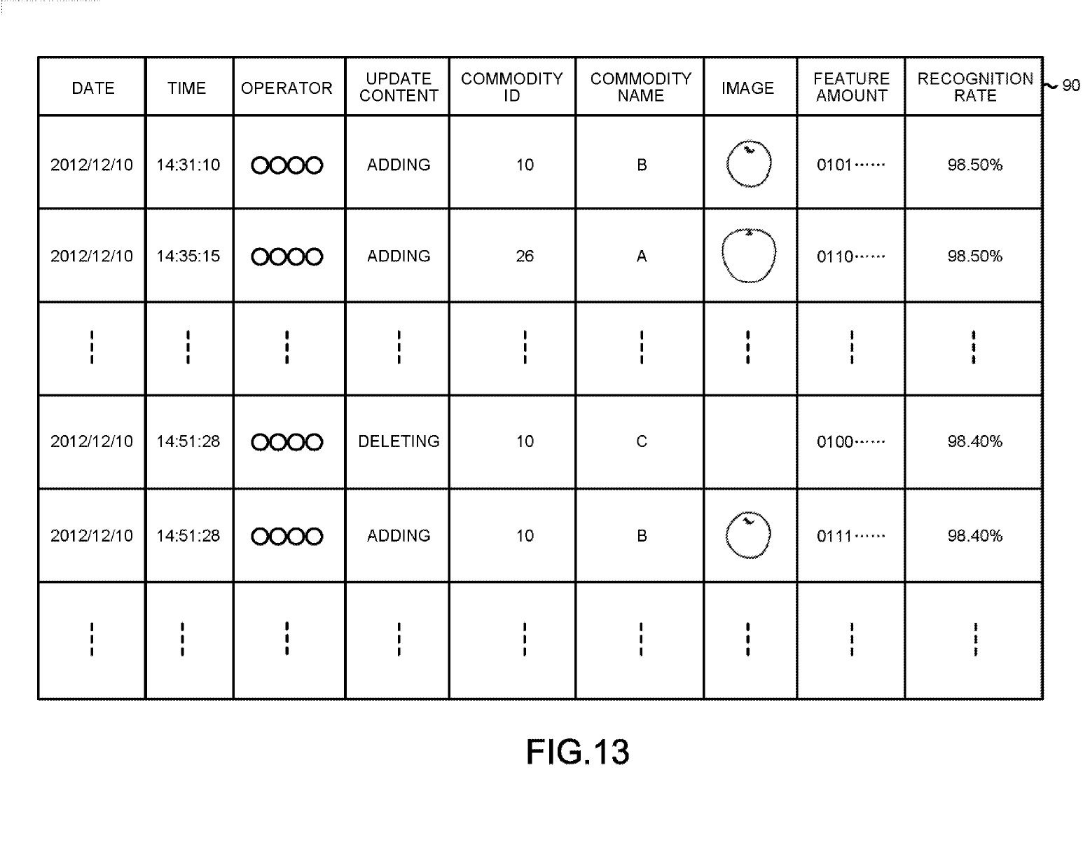

After the retrieval of the log file 50 is ended (YES in ACT 47), the CPU 201 edits the display data of a log output list 90 having, for example, a layout shown in FIG. 13 from the log data 50D stored in the log output area. Then the CPU 201 outputs and visually displays the display data of the log output list 90 on the display for operator 22 (ACT 48). In this way, the information processing according to the log verification program is ended.

As shown in FIG. 13, the person in charge of the maintenance job can easily know, from the log output list 90, the following information such as the date and time when the feature amount data is added, the operator that added the feature amount data, the commodity (commodity ID, commodity name) of which the feature amount data is added, and the change in the recognition rate of the recognition dictionary file 30 due to the addition.

In a case in which the commodity held to the reading window 1B of the scanner unit 1 is recognized to be a commodity of which the similarity degree is ranked at the second place or below through the object recognition technology using the recognition dictionary file 30, the feature amount data can be added according to the determination of the cashier, and besides, it can be easily verified whether or not the addition is correct. If it is determined that the recognition rate of the recognition dictionary file 30 is lowered due to an incorrect addition, the feature amount data added incorrectly can be specified from the content of the log output list 90, thus, a repairing processing can be easily carried out. In this case, since other feature amount data deleted due to the addition of the feature amount data is also recorded in the log output list 90, the deleted feature amount data can easily be restored.

The present invention is not limited to the embodiment described above.

For example, it is exemplified in the embodiment described above that the functions of the commodity recognition apparatus are included in the scanner unit 1 and the POS terminal 2 of the store checkout system. However, the present invention is not limited to this. It may be of such a constitution that the POS terminal 2 is provided with the image capturing module to function as the commodity recognition apparatus all by itself. Further, the data files such as the recognition dictionary file 30, the recognition rate file 40, the log file 50 and the like are not limited to be stored in the auxiliary storage section 204 of the POS terminal 2. At least part of the data files mentioned above may be stored in a store server which is connected through the communication interface 206, and each function of the commodity recognition apparatus may be realized through the cooperation between the POS terminal 2 and the store server.

In the embodiment described above, as long as the number of times the feature amount data of the recognition dictionary data 30D is updated is greater than the threshold value N, every time the feature amount data of the recognition dictionary data 30D is updated, each processing in ACT 32-ACT 36 in FIG. 9 is executed and the correct recognition rate of the recognition dictionary file 30 is sampled. However, the sampling timing is not limited to this. For example, the correct recognition rate of the recognition dictionary file 30 may be sampled every time a preset time elapses.

In the embodiment described above, a case is exemplified in which the log output list 90 is output to be displayed. However, the output method is not limited to the display. For example, the log output list 90 may be output to be printed by a network printer connected through the communication interface 206.

In the embodiment described above, it is exemplified that the update log data 50D is stored in the log file 50 when the feature amount data of the recognition dictionary data 30D which is already stored in the recognition dictionary file 30 is updated. However, the present invention is not limited to this. For example, in a case of adding the recognition dictionary data 30D of a new commodity which is not yet stored in the recognition dictionary file 30 to the recognition dictionary file 30, the additional log data 50D1 may be created and stored for the feature amount data contained in the recognition dictionary data. Similarly, in a case of deleting the recognition dictionary data 30D of the commodity which is not sold any more from the recognition dictionary file 30, the deleted log data 50D2 may be created and stored for the feature amount data contained in the recognition dictionary data.

In addition, the transfer of the commodity recognition apparatus is generally carried out in a state in which the programs such as the commodity recognition program, the recognition rate calculation program and the log verification program are stored in the ROM or the auxiliary storage section. However, the present invention is not limited to this. The programs transferred separately from a computer device may be written in a writable storage device of the computer device through an operation of a user and the like. The transfer of the programs may be carried out by recording the programs in a removable recording medium, or through a communication via a network. The form of the recording medium is not limited as long as the recording medium can store programs like a CD-ROM, a memory card and the like, and is readable by an apparatus. Further, the function realized by an installed or downloaded program can also be realized through the cooperation with an OS (Operating System) installed in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity recognition apparatus comprising:
an extraction module configured to extract, from an image captured by an image capturing module, an appearance feature amount of a target commodity contained in the image;
a recognition module configured to compare the appearance feature amount data extracted by the extraction module with feature amount data of each commodity stored in a recognition dictionary file to recognize the target commodity;
a reception module configured to receive, if a commodity is recognized as candidate of the target commodity by the recognition module, a selection input of the target commodity from the candidate;
an adding module configured to add the appearance feature amount data extracted by the extraction module to the feature amount data stored in the recognition dictionary file in association with an item of the target commodity the selection input of which is received by the reception module; and
a log writing module configured to write log data containing the date and time when the appearance feature amount data is added to the recognition dictionary file by the adding module in a log storage section.

2. The commodity recognition apparatus according to claim 1, wherein
the log writing module includes a module which writes, when other feature amount data is deleted from the recognition dictionary file in response to the addition of the appearance feature amount data to the recognition dictionary file performed by the adding module, log data containing the date and time when other feature amount data is deleted in the log storage section.

3. The commodity recognition apparatus according to claim 1, further comprising:
an output module configured to visually output the log data stored in the log storage section.

4. The commodity recognition apparatus according to claim 3, further comprising:
a calculation module configured to calculate a correct recognition rate at which each commodity can be correctly recognized by the recognition module using the feature amount data of each commodity stored in the recognition dictionary file; and
a recognition rate writing module configured to write the correct recognition rate calculated by the calculation module in a recognition rate storage section together with the date and time when the correct recognition rate is calculated; wherein
the output module visually outputs the correct recognition rate stored in the recognition rate storage section together with the closest date and time after the date and time contained in the log data in association with the log data.

5. The commodity recognition apparatus according to claim 1, further comprising:
a cutting out module configured to cut out, from an image captured by the image capturing module, the image of the target commodity contained in the image; wherein
the log data written in the log storage section contains the image of the target commodity cut out by the cutting out module.

6. A commodity recognition method, including:
extracting, from an image captured by an image capturing module, an appearance feature amount of a target commodity contained in the image;
comparing the extracted appearance feature amount data with feature amount data of each commodity stored in a recognition dictionary file to recognize the target commodity;
receiving, if a commodity is recognized as candidate of the target commodity, a selection input of the target commodity from the candidate;
adding the extracted appearance feature amount data to the feature amount data stored in the recognition dictionary file in association with an item of the target commodity the selection input of which is received; and
writing log data containing the date and time when the appearance feature amount data is added to the recognition dictionary file in a log storage section.
